(19) United States
(12) Patent Application Publication
(10) Pub. No.: US 2018/0030777 A1
(43) Pub. Date: Feb. 1, 2018

(54) Gear Driven Louver Shutter System

(71) Applicant: Tony Yen, San Diego, CA (US)

(72) Inventor: Tony Yen, San Diego, CA (US)

(21) Appl. No.: 15/726,328

(22) Filed: Oct. 5, 2017

Related U.S. Application Data
(63) Continuation-in-part of application No. 15/437,132, filed on Feb. 20, 2017.

(30) Foreign Application Priority Data
May 23, 2016 (CN) 201620468165.5

(51) Int. Cl. E06B 7/096; E06B 7/09

(52) U.S. Cl. CPC E06B 7/096; E06B 7/09

(57) ABSTRACT

The present invention is a gear driven louver shutter system, wherein each louver of the shutter system is attached to the end of a pinion at both its ends. The base of each pinion is engaged with a gear strip disposed within each frame member, with a glide strip having a channel for the gear strip to glide within. When one louver is adjusted, all the louvers in the shutter system will move accordingly, due to the movement of the gear strip rotating the pinions in that frame member at the same rate. The glide strip may be held within the frame member by a friction fit or a clamping groove on the inside wall of the frame member.

### CROSS-REFERENCE TO RELATED APPLICATION(S)

The present application claims priority to Chinese Patent Application No. 201620468165.5 filed on May 23, 2016, entitled “Invisible Tilt Gear”, and is a Continuation in Part of U.S. Ser. No. 15/437,132, filed on Feb. 20, 2017 and entitled “Gear Driven Louver Shutter System”, the entire disclosure of which is incorporated by reference herein.

### BACKGROUND OF THE INVENTION

### 1. Field of Invention

The present invention relates to the field of shutter systems, and more specifically to shutter systems which utilize a plurality of adjustable louvers.

### 2. Description of Related Art

Louvers were first seen in the Middle Ages to allow ventilation, while still offering protection against natural elements such as rain, snow, or heavy wind. These louver systems were primarily comprised of fixed louvers and were commonly placed onto roof holes in kitchens to allow smoke and steam to escape.

Modern shutter systems, which utilize a plurality louvers, first started appearing in the early 1900s. The louvers of the shutters were adjustable and could be open or closed when a user pulled a handle or turned a hand-crank. All of the louvers in the shutter system would be connected with a tilt bar, such that all of the louvers in the system would remain parallel as they were adjusted. The louvers were commonly made from wood, glass, vinyl, PVC, or aluminum.

Many louver assemblies seen today do not come equipped with a handle or hand crank, instead the user simply adjusts the tilt bar or one of the louvers to adjust the angle of all of the louvers in the assembly. While a tilt bar can successfully keep all louvers of a shutter assembly in a parallel with one another, it can be an unsightly feature which some users prefer not to look at. Hidden tilt bars may be used which nest inside the stile of the shutters, however their implementation prevents the louvers from fully closing in both direction.

Based on the foregoing, there is a need in the art for a shutter assembly wherein the tilt of the louvers may be controlled by a hidden apparatus. What may be further desired is a hidden apparatus to control the tilt of the louvers and allows for the louvers to be closed in both directions without obstruction of the view.

### SUMMARY OF THE INVENTION

The present invention is a louver shutter system. In a preferred embodiment, the louver shutter system is comprised of two frame members. Two gear strips are disposed in each of the two frame members. Pinions, provided with a plurality of teeth, are inserted into the frame members. The teeth of the pinons are engaged with the gear strips, such that movement of the gear strips causes the pinons to rotate. Conversely, rotation of the pinons will cause the gear strips to move.

In a preferred embodiment, the louver shutter system is comprised of two frame members with one gear strip disposed in each of the two frame members. A glide strip is positioned between the gear strip and the inside wall of the frame, and in an embodiment the glide strip has a lip along either edge, which provides a channel for the gear strip to glide within. The glide strip may be held against the inside wall by a friction fit or by protrusions from the side facing the inside wall interacting and engaging with grooves or clamps on the inside wall. Pinions, provided with a plurality of teeth similarly engage with the single gear strip in each frame member, such that movement of the gear strips causes the pinons to rotate. Conversely, rotation of the pinons will cause the gear strips to move.

In the preferred embodiment, when one pinion is rotated, all the pinons of the same frame member will rotate to the same degree, as all the pinons are engaged with the same gear strips.

In the preferred embodiment, each pinion is provided with one or more connector pins to attach to the end of a louver. A plurality of louvers is provided between the two frame members, and connected to the pinions via the connector pins. In the preferred embodiment, the louvers are attached to the pinions without the use of a tool. When the louvers are attached to the frame members, rotating one louver will cause all other louvers in the assembly to rotate to the same angle. In the preferred embodiment, the louvers are assembled to be parallel to one another and remain parallel during rotation.

In an embodiment, the connector pins are further provided with a louver clip component. The louver clip is positioned between the louver and the connector pins of the pinion, and allows an easier attachment of the louver to the connector pins. In another embodiment, the connector pins are further provided with a plurality of teeth. The teeth prevent the slipping when the connector pins are engaged with the louvers or louver clips.

In an embodiment of the present invention, the louvers are provided with a S-shaped profile. The S-shaped profile allows the louvers to overlap without spaces, such that light is completely blocked when the louvers are moved into a closed position.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a front elevational view of the gear driven louver shutter system, according to an embodiment of the present invention;

FIG. 2 is a perspective view of the frame component of the gear driven louver shutter system, according to an embodiment of the present invention;

FIG. 3 is a perspective view of the pinion component of the gear driven louver shutter system, according to an embodiment of the present invention;

FIG. 4 is a cross-section view of the gear driven louver shutter system, according to an embodiment of the present invention;

FIG. 5 is a cross-section view of the gear driven louver shutter system, according to an embodiment of the present invention;

FIG. 6 is an exploded view of the gear driven louver shutter system, according to an embodiment of the present invention;

FIG. 7 is an exploded view of the gear driven louver shutter system, according to an embodiment of the present invention;

FIG. 8 is a perspective view of the connector pin of the gear driven louver shutter system, according to an embodiment of the present invention;

FIG. 9 is a front elevational view of the gear driven louver shutter system, according to an embodiment of the present invention;

FIG. 10 is a cut away of the frame member gear driven louver shutter system, according to an embodiment of the present invention;

FIG. 11 is a cross-section view of the gear driven louver shutter system, according to an embodiment of the present invention; and

FIG. 12 is a perspective view of the frame component of the gear driven louver shutter system, according to an embodiment of the present invention.

### DETAILED DESCRIPTION OF PREFERRED EMBODIMENTS

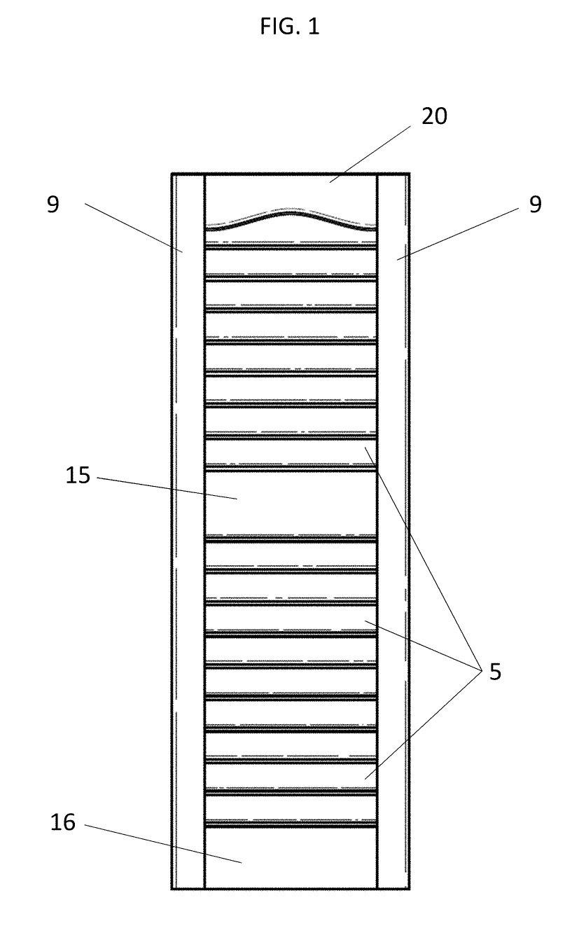

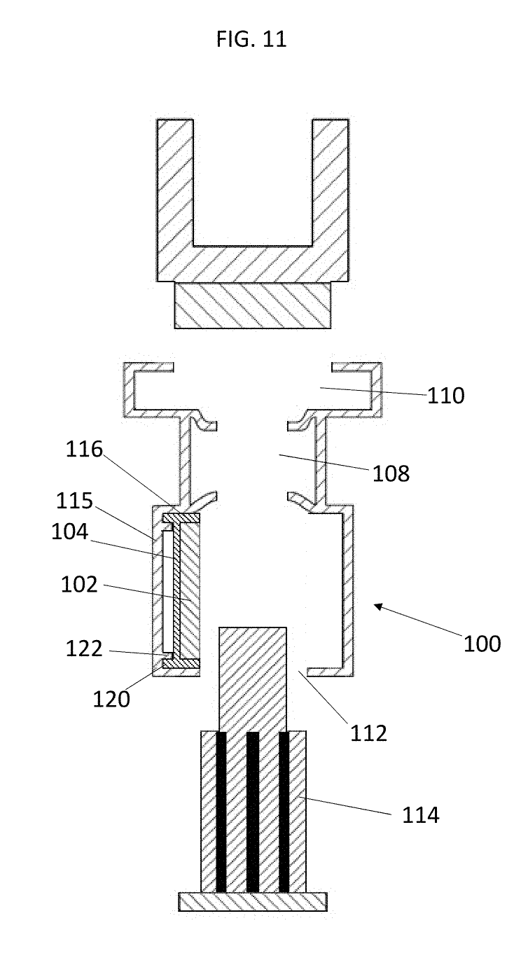

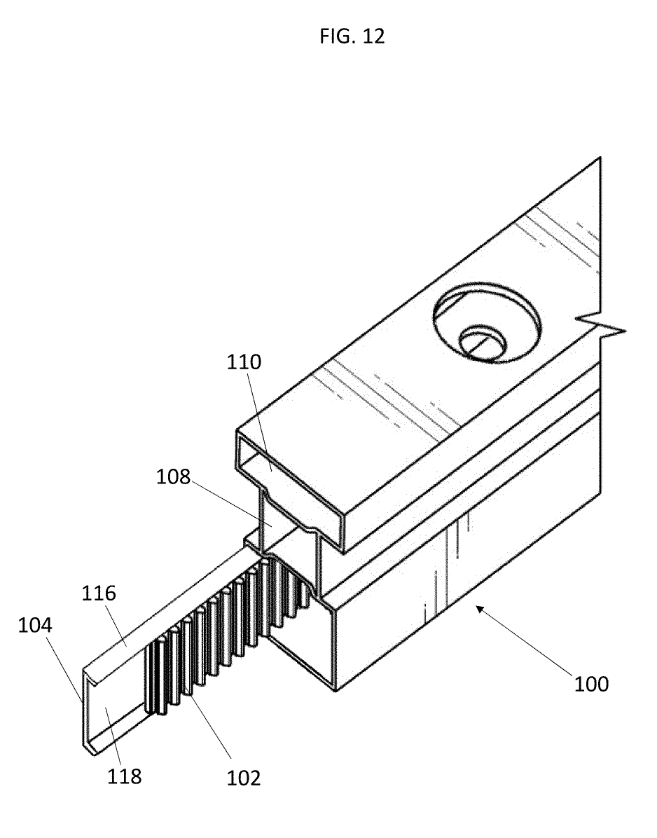

Preferred embodiments of the present invention and their advantages may be understood by referring to FIGS. 1-12, wherein like reference numerals refer to like elements.

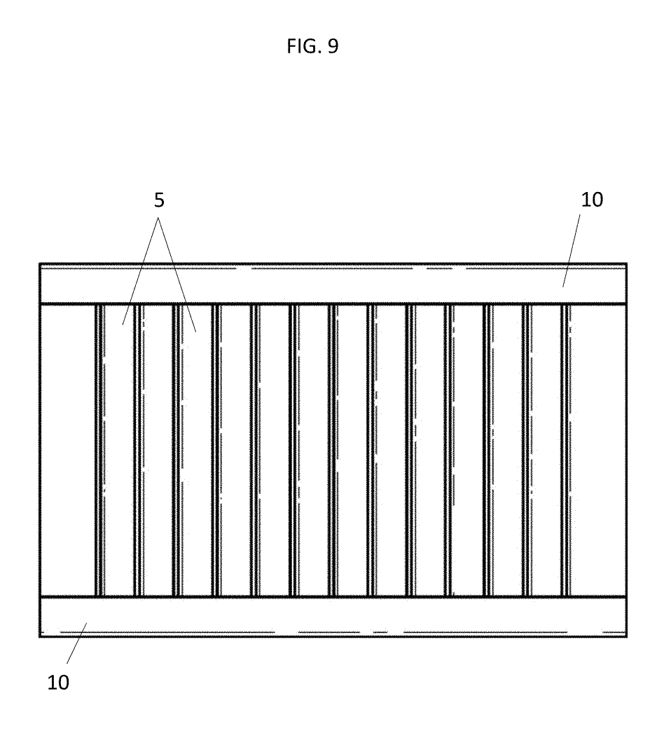

In reference to FIG. 1, a complete shutter assembly is shown, wherein a plurality of louvers 5 have been mounted to the frame members (not shown) and the frame members have been inserted into the stiles 9. In the embodiment, the louvers 5 are positioned horizontally, in another embodiment, the louvers 5 may be positioned vertically (as shown in FIG. 9). In the embodiment, the shutter assembly if further comprised of a midrail 15, a bottom rail 16, and a top rail 20. In another embodiment, the shutter assembly may contain more midrails, bottom rails, top rails, or none at all.

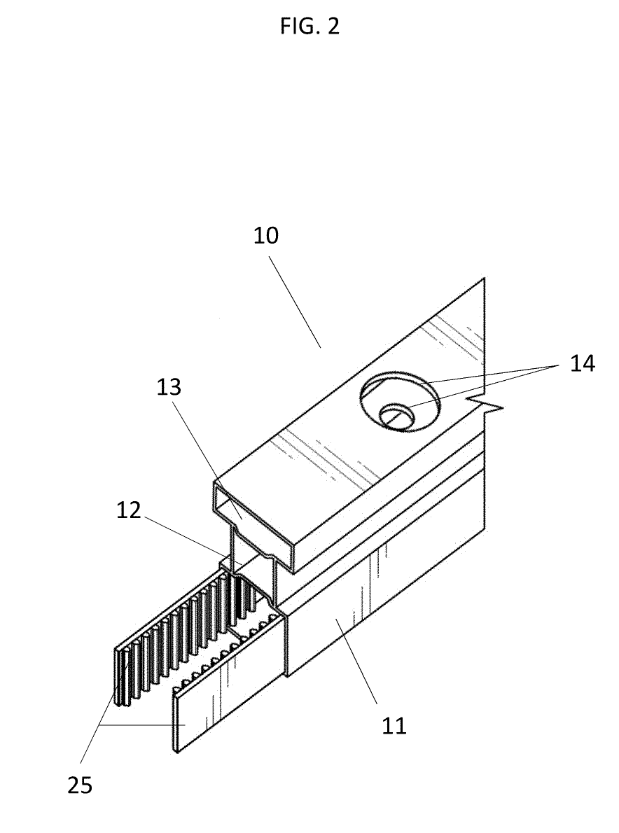

In reference to FIG. 2, according to an embodiment of the present invention, a frame member 10 is shown with two gear strips 25 inserted into the gear track 11 of the frame member 10. The frame member 10 is further comprised of a shaft cavity 12, a neck cavity 13, and drilled holes 14 such that the frame member is able to receive a pinion (not shown).

In the preferred embodiment, the frame member 10 is comprised of aluminum which is created via extrusion. In another embodiment, the frame member 10 may be any metal, wood, plastic, or other material deemed suitable.

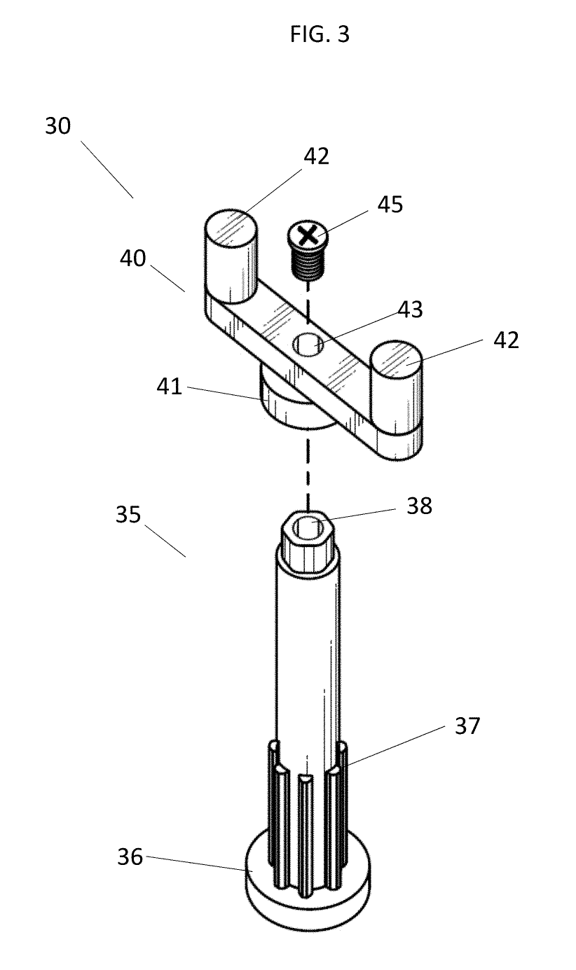

In reference to FIG. 3, according to an embodiment of the present invention, a pinion 30 is comprised of a gear drive shaft 35 and connector pin 40. In an embodiment, the shaft 35 is further comprised of a guide washer 36, to retain the pinion 30 inside the frame member (not shown). The shaft 35 further comprises of a plurality of gears 37 to engage with a gear strip (not shown).

In an embodiment, the connector pin 40 is further comprised of a line-up joint 41 to retain the position of the pinion 30 when inserted into a frame member (not shown). The connector pin is further comprised of two louver pins 42 to adapted to engage with a louver or louver clip (not shown). In another embodiment, the connector pin may have one louver pin with teeth or more than two louver pins.

In the embodiment shown in FIG. 3, the gear drive shaft 35 and connector pin 40 are fastened together to form the pinion 30, via a connector screw 45. The connector screw 45 is received by a counter-sunk aperture 43, provided in the connector pin 40, and a threaded aperture 38 provided on the gear drive shaft 40. In the embodiment, a Philips type screw is used, however the screw used may be any type. In another embodiment, attachment of the shaft and pin may be achieved using a nut and bolt, snap on, or other connection deemed appropriate. In the preferred embodiment, the end of the gear drive shaft 35 is a hexagonal shape provided to engage with the line-up joint 41 to prevent slipping between the pin and shaft. In another embodiment, the end of the gear drive shaft may be provided with teeth, be square, or another shape to prevent slipping between the pin and the shaft.

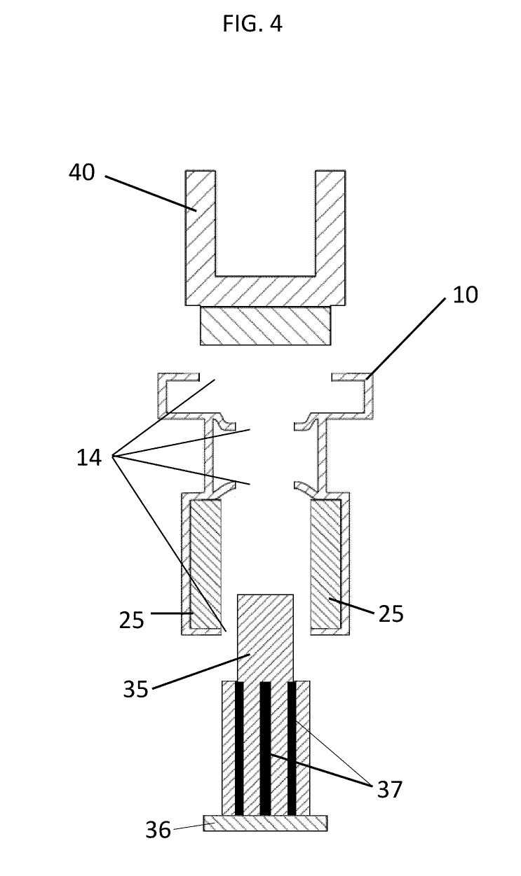

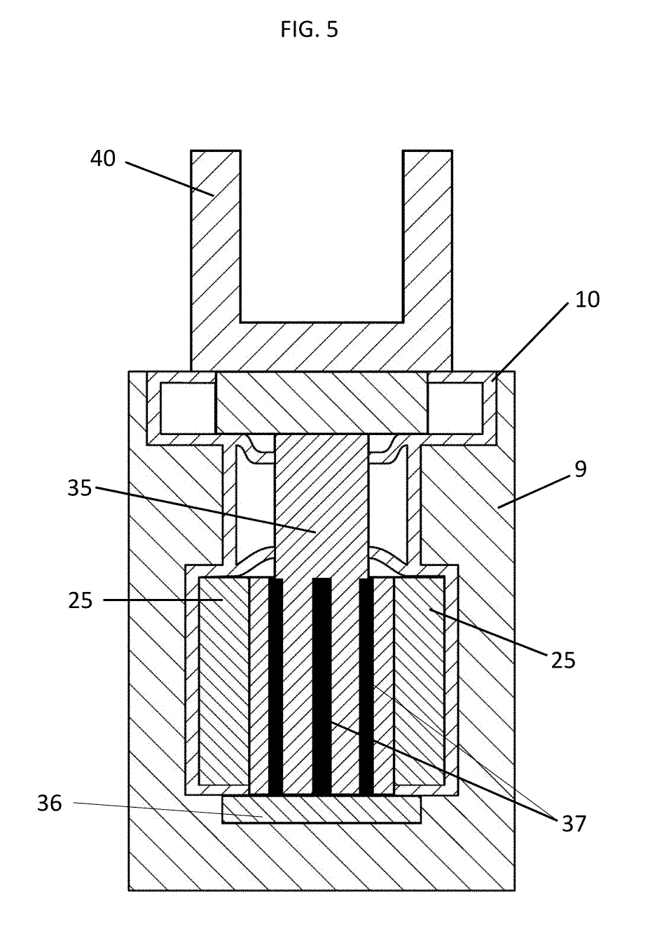

In reference to FIG. 4-5, a cross-sectional view of a pinion to be inserted into a frame member 10 is shown. In the embodiment shown, the frame member 10 has been drilled with four holes 14 to accommodate the pinion. The same four holes will be drilled at any location along the length of the frame member 10 in which a pinion is to be placed. In the embodiment, the gear drive shaft 35 and connector pin 40 are inserted separately into the holes 14 on opposing sides of the frame member 10, then assembled or connected via the preferred method of attachment.

When properly assembled, the gears 37 of the pinion are engaged with the gear strips 25, such that rotation of a pinion causes the gear strips to slide within the gear track. The rotation of one pinion, will then cause all other pinions assembled in the frame member to rotate in the same manner In the preferred embodiment, the assembled frame member is then inserted into a stile 9. The stile is provided to retain the frame members and hide the conceal the components of the assembly.

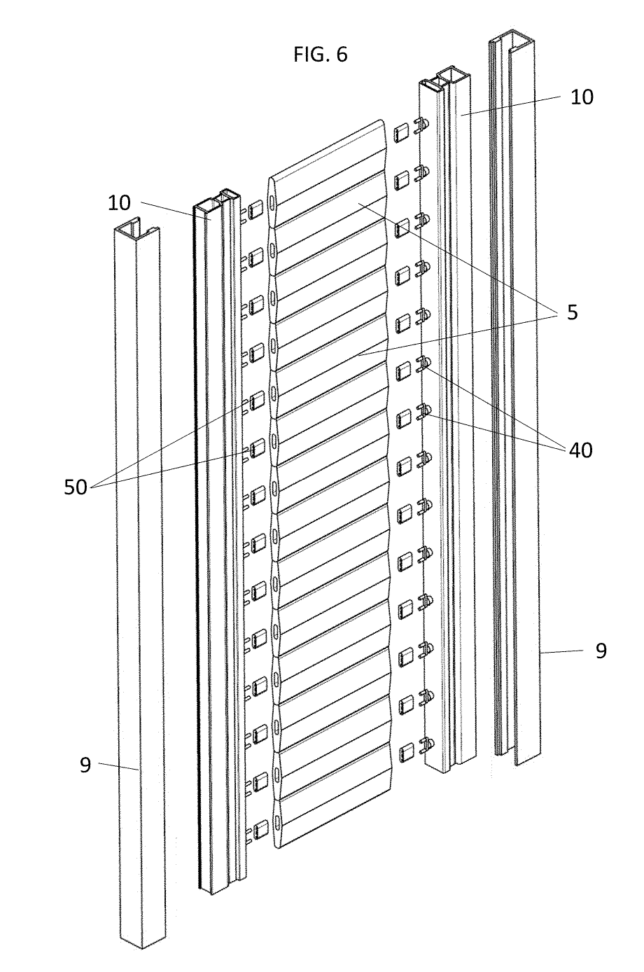

In reference to FIG. 6, according to an embodiment of the present invention, a shutter assembly is shown in an exploded state, having pinions and gear strips (not shown) assembled into the frame members 10. In the embodiment shown, louver clips 50 are provided to be inserted into the louvers 5 and attached to the connector pins 40 of the pinion. In the embodiments, the louver clips 50 are snapped onto the connector pins 40 and snapped into the louvers 5. In other embodiments, the louver clips 50 may be adhered into the louvers 5 or fit into the louvers with a transitional tolerance. In another embodiment, the louvers may contain holes which allow for direct insertion of the connector pins 40 into the louvers 5 without a louver clip.

In a preferred embodiment, each the frame members 10 are inserted into a stile 9 after they are assembled. The stiles 9, are provided to conceal the components of the frame member which may be considered unsightly. When utilized, the stiles 9 give the shutter system a clean appearance without a tilt bar.

In the embodiment, the louvers are assembled in position to be parallel with one another. The assembly is provided to allow a user to tilt one louver, twisting its pinions and moving the gear strip to tilt all the louvers in the assembly, such that they remain parallel with one another. This arrangement relinquishes the need for a tilt bar, as seen in most shutter assemblies.

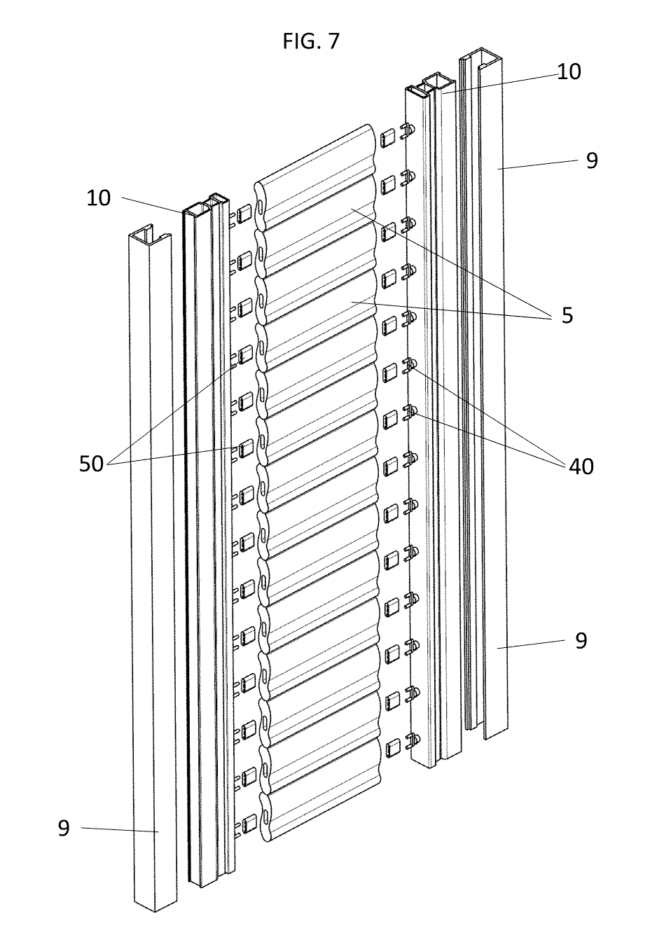

In reference to FIG. 7, according to an embodiment of the present invention, the same shutter assembly of FIG. 6 is shown, wherein louvers 5 are shown having a curved profile as a variation. The curved profile allows for light for complete blocking of light when the louvers 5 are arranged with a slight overlap. It could be appreciated, that the profile of the louvers may be further varied to achieve a desired aesthetic.

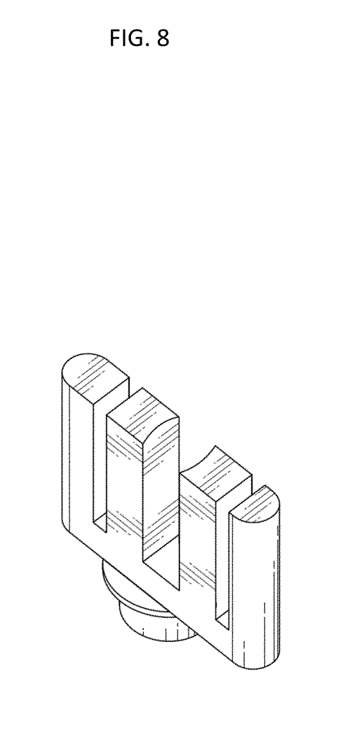

In reference to FIG. 8, according to an embodiment of the present invention, a variation of the connector pin is shown have four pins to engage with a louver clip or louver. In the variation shown, the connector pin does not have an aperture for a fastening component such as a screw, however one can consider additional variations of the connector pin in which an aperture for a fastener is provided. In another embodiment, varying pin numbers and shapes may be used.

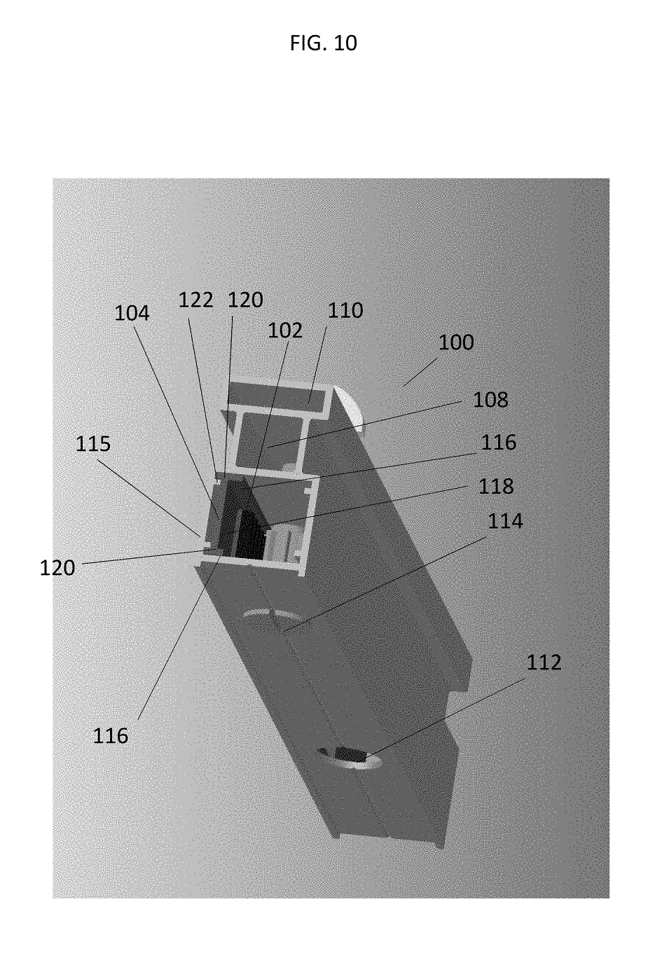

In reference to FIG. 10-12, according to an embodiment of the present invention, a frame member 100 is shown with a gear strip 102 inserted into the frame member 100. A low-friction glide strip 104 is interposed between the gear strip 102 and a wall 115 of the frame member. The frame member 100 is further comprised of a shaft cavity 108, an optional neck cavity 110, and pinion holes 112 such that the frame member is able to receive a pinion 114. The pinion 114 may be inserted through a pinion hole 112 to interface with the gear strip 102 within the frame member 100.

In an embodiment, the glide strip 104 has two protrusions 116 forming a channel 118, within which the gear strip 102 may glide, without contacting the walls of the frame member 100. The glide strip may be made of a low-friction plastic material known in the art, that reduces the friction between a sliding gear strip 102 and channel 118.

The glide strip may be held within the gear track with a friction fit, and/or may have one or more protrusions 120 on the reverse to interface with a clamp or groove 122 on the inside wall of the frame member.

In the preferred embodiment, the frame member 10 and frame member 100 are comprised of aluminum, which is created via extrusion. In another embodiment, the frame member 10 or 100 may be any metal, wood, plastic, or other material deemed suitable.

In the preferred embodiment, the louvers are comprised of wood. In other embodiments, the louvers may be comprised of vinyl, polyvinyl chloride (PVC), composite, acrylic, aluminum, or any material deemed suitable. In the preferred embodiment, the pinions and gear strips are comprised of plastic. In another embodiment, the pinions and gear strips may be comprised of vinyl, polyvinyl chloride (PVC), composite, acrylic, aluminum, or any material deemed suitable.

In an embodiment of the present invention, an electric motor with a pinon adapted to engage with the gear strips can be implemented to create an electrically driven shutter system. In the embodiment, a remote system may be added to control the motor via remote control, allowing the shutters to be open and closed using a remote. Furthermore, this system could be adapted to an internet of things to allow a user to open and close shutter systems in their home using their mobile device.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A louver shutter system comprising:
a. two frame members separated by a plurality of louvers;
b. a gear strip disposed within each of the two frame members;
c. a glide strip within each of the two frame members positioned between an inside wall of the frame member and the gear strip such that the glide strip is on contact with the gear strip;
d. at least one pinion projecting from each frame, the pinion having:
i. a gear engaged with the gear strip within the frame at an end of the pinion; and
ii. one or more connector pins at an opposite end of the pinion to attach to a louver,
wherein each pinion extends into one of the frame members such that rotation of the pinion rotates a louver at the opposite end.

2. The louver shutter system of claim 1, further comprising a plurality of louver clips to engage with the one or more connector pins and insert into the plurality of louvers.

3. The louver shutter system of claim 1, wherein each louver of the plurality of louvers is provided with an S-shaped cross section configured to seal with an adjacent louver and block light.

4. The louver shutter system of claim 1, wherein all louvers of the plurality of louvers are provided in parallel relative to one another.

5. The louver shutter system of claim 1, wherein the one or more connector pins are further provided with a plurality of teeth to prevent slipping.

6. The louver shutter system of claim 1, wherein the plurality louvers are adapted to snap onto the one or more connector pins without the use of a tool.

7. The louver shutter system of claim 1, wherein the glide strip has a lip at each side forming a channel within which the gear strip may glide without contacting the inside wall.

8. The louver shutter system of claim 1, wherein the glide strip is positioned adjacent to the inside wall with a friction fit.

9. The louver system of claim 1, wherein the glide strip has one or more protrusions on the side facing the inside wall, and wherein the frame member inside wall has a groove on the inside wall configured to receive the protrusions.
